(19) United States
(12) Patent Application Publication
(10) Pub. No.: US 2014/0372878 A1
(43) Pub. Date: Dec. 18, 2014

(54) TEXT EDITING SYSTEM AND METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventor: YU-CUI ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/140,579

(22) Filed: Dec. 26, 2013

(30) Foreign Application Priority Data
Jun. 13, 2013 (CN) 2013102333230

(51) Int. Cl. G06F 17/24

(52) U.S. Cl. CPC G06F 17/24
USPC 715/256

(57) ABSTRACT

A text editing system for automatically performing a common editing format is provided. The text editing system includes one or more processors; and a plurality of modules programmed and executed by the one or more processors. The plurality of modules includes a modifying module to determine if one or more items is modified. A storing module stores content of one or more modified items in a memory when the one or more items is modified. A comparing module determines a quantity of the one or more modified items having same content, and compares the quantity with a predetermined number. A setting module updates content of the one or more modified items in the common editing format when the quantity is greater than the predetermined number. A performing module performs text inputting according to the updated content of the one or more modified items in the common editing format.

### BACKGROUND

1. Technical Field

The present disclosure relates to text editing systems and methods, and particularly to a text editing system and method for automatically performing a common editing format.

2. Description of Related Art

Text editors such as word processors were developed to allow formatting of text for presentation on a printed page, such as input data for a computer program. However, such text editors edit inputted text in a default format, such as default fonts, size, or color, for example.

Therefore, it is desirable to provide a text editing system to overcome this shortcoming.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a schematic view of an embodiment of a text editing system for automatically performing a common editing format.

FIG. 2 is a flowchart of a text editing method for automatically performing a common editing format performed by the text editing system of FIG. 1.

### DETAILED DESCRIPTION

Embodiments of the present disclosure will be described with reference to the drawings.

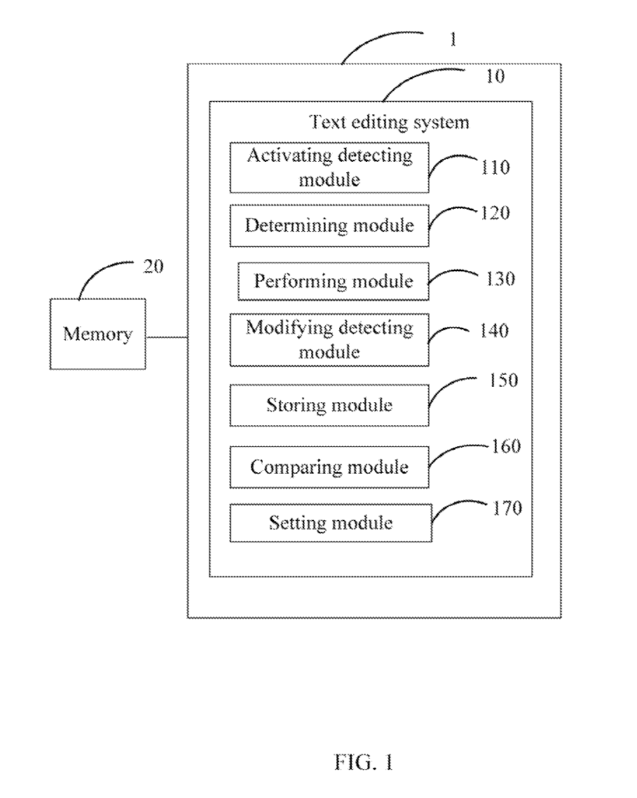

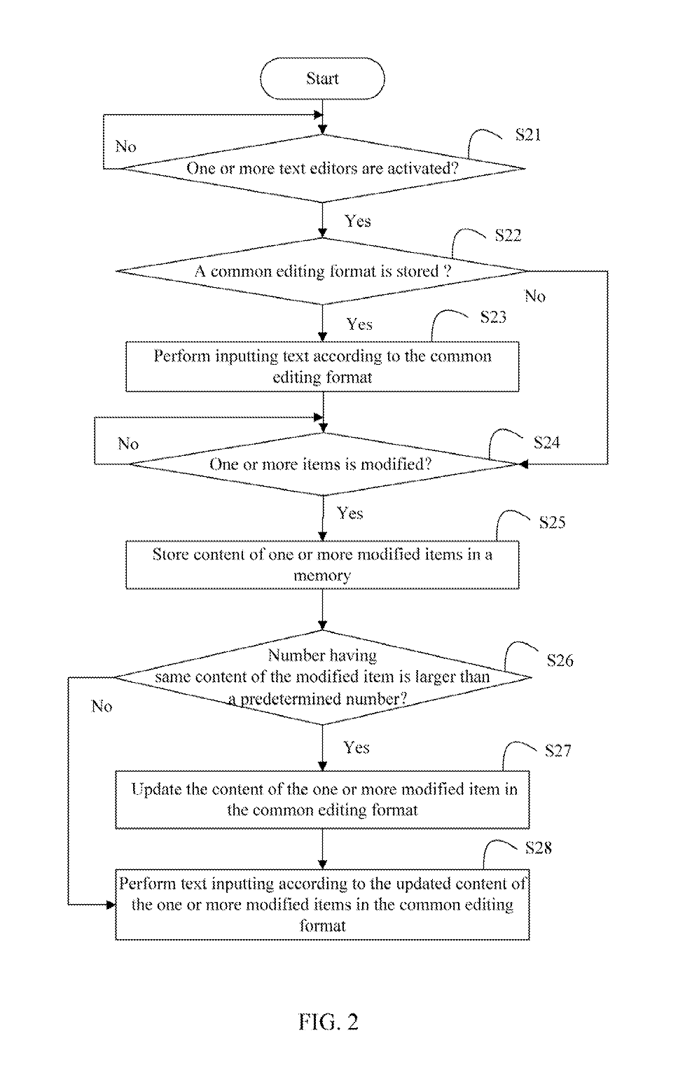

FIG. 1 is a schematic view of an embodiment of a text editing system for automatically performing a common editing format. The common editing format is a common way for manually inputting text. The text editing system 10 is software and runs on a processor 1. The text editing system 10 is connected to a memory 20 supplying space for data. The text editing system 10 includes an activating detecting module 110, a determining module 120, a performing module 130, a modifying detecting module 140, a storing module 150, a comparing module 160, and a setting module 170. Functions of the modules will be described together with FIG. 2.

FIG. 2 is a flowchart of a text editing method for automatically performing a common editing format performed by the text editing system 10 of FIG. 1.

In step S21, the activating detecting module 110 determines whether one or more text editors are activated, such as word processors, emails, and chatting tools. If yes, the procedure goes to step S22, and if no, the procedure repeats step S21. In detail, the activating detecting module 110 scans to determine if any text needs to be input in each running application.

In step S22, the determining module 120 determines if a common editing format is stored in the memory 20. If yes, the procedure goes to step S23. If no, the procedure goes to step S24. The common editing format is a common way to manually input text, such as common font, size, or color, for example.

In step S23, the performing module 130 performs inputting text according to the common editing format. Different users may have different common editing formats. The performing module 103 can perform text inputting according to the common editing format corresponding to the login user. If there is no common editing format corresponding to the login user, the performing module 103 performs inputting text according to a default editing format.

In step S24, the modifying module 140 determines if one or more items in the common editing format is modified by a user. If yes, the procedure goes to step S25. If no, the procedure repeats step S24.

In step S25, the storing module 150 stores content of modified items in the memory 20. For example, if the modified item is font, and the user modifies the font from 14 to 12, then the font 12 is stored in the memory 20.

In step S26, the comparing module 160 determines a quantity of the modified items that have the same content, and compares the quantity with a predetermined number. If the quantity is greater than the predetermined number, the content of the modified item is determined to be one common item in the common editing format, and the procedure goes to the step S27. Otherwise, the procedure goes to the step S28. For example, if font 12 is stored in the memory 20 three times, and the predetermined number is three, then font 12 is regarded to be one common item in the common editing format.

In step S27, the setting module 170 updates content of the modified item, such as font 12, in the common editing format.

In step S28, the performing module 130 performs text inputting according to the updated common editing format.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A text editing system for automatically performing a common editing format, connected to a memory for storing data, the text editing system comprising one or more processors and a plurality of modules programmed and executed by the one or more processors to execute the text editing system, wherein the plurality of modules comprises:
a modifying module to determine if one or more items is modified;
a storing module to store content of the one or more modified items in the memory when the one or more items is modified;
a comparing module to determine a quantity of the one or more modified items having the same content, and compare the quantity with a predetermined number;
a setting module to update the content of the one or more modified items in the common editing format when the quantity is greater than the predetermined number; and
a performing module to perform text inputting according to the updated content of the one or more modified items in the common editing format.

2. The text editing system of claim 1, wherein the plurality of modules further comprises an activating detecting module to determine whether one or more text editors are activated, and a determining module to determine if the common editing format is stored in the memory; and the performing module also performs inputting text according to the common editing format when one or more text editors are activated.

3. The text editing system of claim 1, wherein the performing module also performs inputting text according to the common editing format corresponding to a login user; when there is no common editing format corresponding to the login user, the performing module performs inputting text according to a default editing format.

4. The text editing system of claim 2, wherein the activating detecting module determines whether one or more text editors are activated by scanning to determine if any text needs to be inputted in each running software.

5. A text editing method for automatically performing a common editing format, wherein the common editing format is a common way for a user to input text, the text editing method comprising:
determining if one or more items is modified;
storing content of one or more modified items in a memory when the one or more items is modified;
determining a quantity of the one or more modified items having the same content, and comparing the quantity with a predetermined number;
updating the content of the one or more modified items in the common editing format when the quantity is greater than the predetermined number; and
performing text inputting according to the updated content of the one or more modified items in the common editing format.

6. The text editing method of claim 5, further comprising determining whether one or more text editors are activated, determining if the common editing format is stored in the memory, and performing inputting text according to the common editing format when one or more text editors are activated.

7. The text editing method of claim 5, wherein the step of performing text inputting according to the updated content of the one or more modified items in the common editing format further comprises: performing inputting text according to the common editing format corresponding to a login user, and when there is no common editing format corresponding to the login user, and performing inputting text according to a default editing format.

8. The text editing method of claim 6, wherein the step of determining whether one or more text editors are activated is performed by scanning to determine if any text needs to be inputted in each running software.
